(19) United States
(12) Patent Application Publication
(10) Pub. No.: US 2013/0141548 A1
(43) Pub. Date: Jun. 6, 2013

(54) METHOD AND SYSTEM FOR ESTABLISHING 3D OBJECT

(71) Applicant: Hian-Kun Tenn, Kaohsiung City (TW)

(72) Inventor: Hian-Kun Tenn, Kaohsiung City (TW)

(73) Assignee: INDUSTRIAL TECHNOLOGY RESEARCH INSTITUTE, HSINCHU (TW)

(21) Appl. No.: 13/458,237

(22) Filed: Apr. 27, 2012

(30) Foreign Application Priority Data
Dec. 5, 2011 (TW) 100144714

(51) Int. Cl. H04N 13/02

(52) U.S. Cl. 348/50; 348/E13.074

(57) ABSTRACT

A method for establishing a 3D object includes the following steps. Multiple featured patches, with different textured features, on the surface of an object are captured and stored. An image capture unit is utilized to detect the featured patches on the surface of the object. A processing unit is utilized to build a spatial relationship matrix corresponding to the featured patches according to detected space information of the featured patches. The processing unit is utilized to trace and describe the object according to the spatial relationship matrix.

This application claims the benefit of Taiwan application Serial No. 100144714, filed Dec. 5, 2011, the subject matter of which is incorporated herein by reference.

### BACKGROUND

1. Technical Field

The invention relates in general to a method and a system for establishing a 3D object.

2. Background

Augmented Reality (AR) technique calculates spatial information, including positions and orientations, of images captured by cameras in real time, and adds corresponding digital contents to the images according to the spatial information. The technique aims to make a virtual object overlay a real object on the display for entertainment interactions or information display. However, the real object in the conventional augmented reality applications is usually limited to augment the virtual object in a plane graphic card. In general, the augmented virtual object can not be normally displayed if the patterns for system identification are shaded and the system can not trace the plane graphic card. Moreover, it would destroy the immersive of the augmented reality application, and it is hard to spread to augmented applications of the actual 3D object.

The system generally needs to obtain spatial information of the object so as to augment the required virtual interaction contents on the object to implement the augmented reality applications of the 3D object consequently. Existed visual arts build a model of the actual object and fits information of the model into the system, so that the system is able to trace the space posture of the actual object any time to achieve augmented reality applications of the 3D objects. However, the conventional method for establishing a 3D object model needs expensive equipments or complicated and accurate procedures. It does not match general users' requirements, and it is hard to spread to general application fields, such as consumer electronic products.

### SUMMARY

The disclosure is directed to a method and a system for establishing a 3D object, establishing mutual spatial relationships based on postures of multiple featured patches with different textured features, and accordingly tracing and describing an object.

According to a first aspect of the present disclosure, a method for establishing a 3D object is provided. The method includes the following steps. Multiple featured patches, with different textured features, on the surface of an object are captured and stored. An image capture unit is utilized to detect the featured patches on the surface of the object. A processing unit is utilized to build a spatial relationship matrix corresponding to the featured patches according to detected space information of the featured patches. The processing unit is utilized to trace and describe the object according to the spatial relationship matrix.

According to a second aspect of the present disclosure, a system for establishing a 3D object is provided. The system includes an image capture unit and a processing unit. The image capture unit captures and stores multiple featured patches, with different textured features, on a surface of an object. The processing unit builds a spatial relationship matrix corresponding to the featured patches according to detected space information of the featured patches after the image capture unit detects the featured patches, and traces and describes the object according to the spatial relationship matrix.

The invention will become apparent from the following detailed description of the preferred but non-limiting embodiments. The following description is made with reference to the accompanying drawings.

### BRIEF DESCRIPTION OF THE DRAWINGS

FIG. 1 shows a schematic illustration illustrating a system for establishing a 3D object according to an embodiment.

FIG. 2 shows a flow chart of a method for establishing a 3D object according to an embodiment.

FIGS. 3A to 3D show schematic illustrations corresponding to the method for establishing a 3D object according to an embodiment.

### DETAILED DESCRIPTION

The disclosure proposes a method and a system for establishing a 3D object, establishing mutual spatial relationships based on postures of multiple featured patches with different textured features, and accordingly tracing and describing an object.

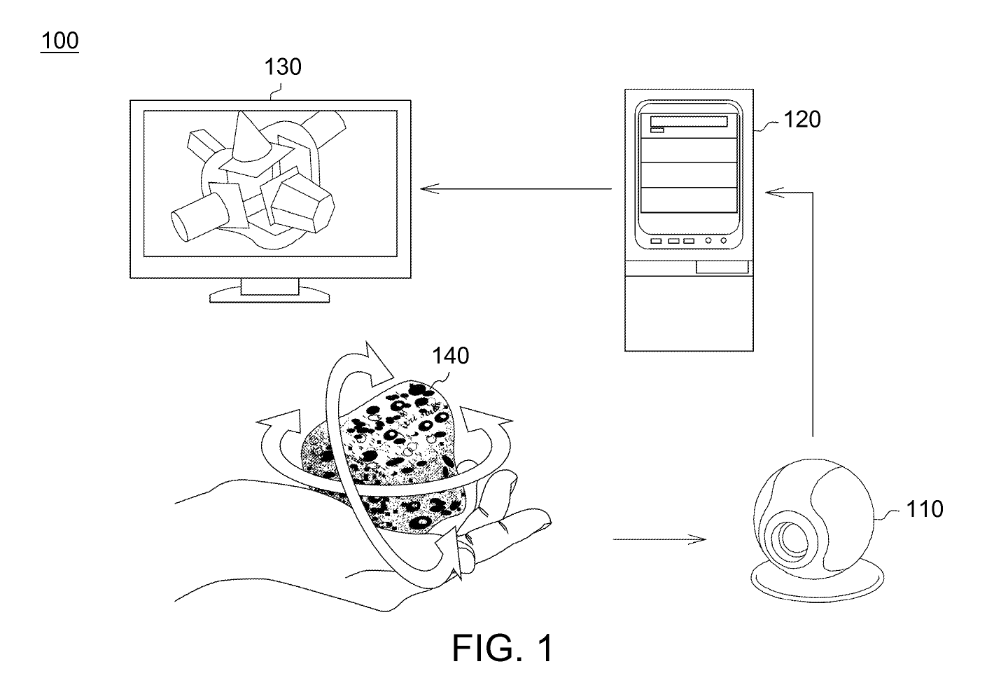

Referring to FIG. 1, a schematic illustration illustrating a system for establishing a 3D object according to an embodiment is shown. The system 100 for establishing a 3D object includes a image capture unit 110, a processing unit 120 and a display unit 130. In the embodiment, elements of the system 100 for establishing a 3D object are shown in a discrete form, but it is not limited. The elements can be integrated into a single apparatus, and it is determined according to requirements. In addition, connections between the elements are not limited either, and the connections may be wire/wireless connections or others.

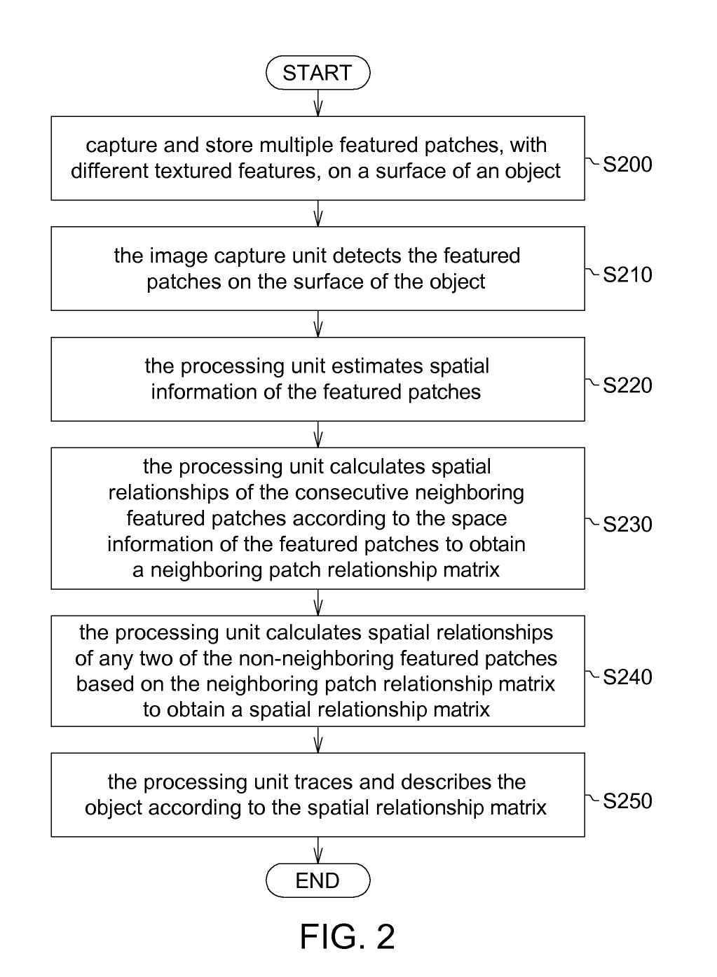

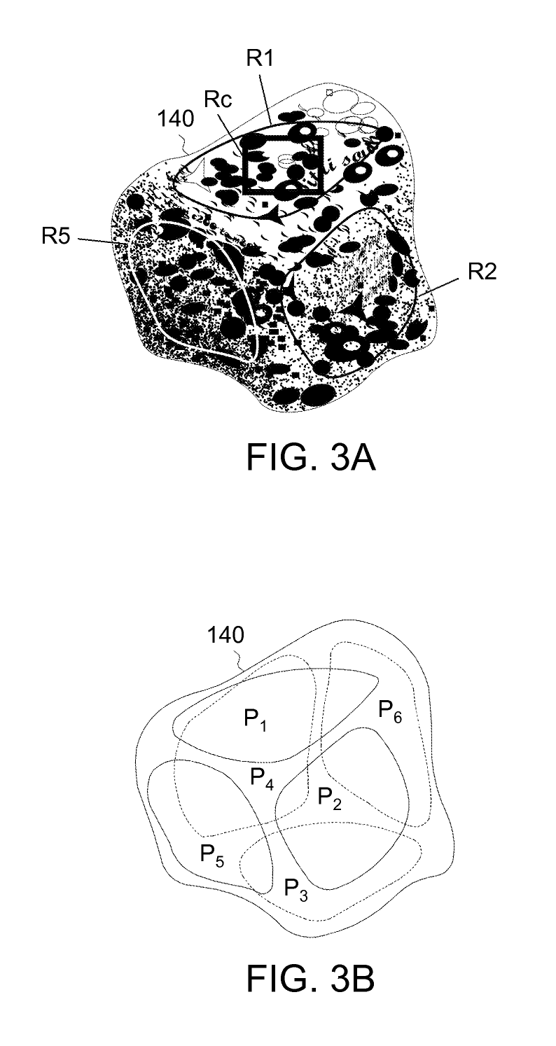

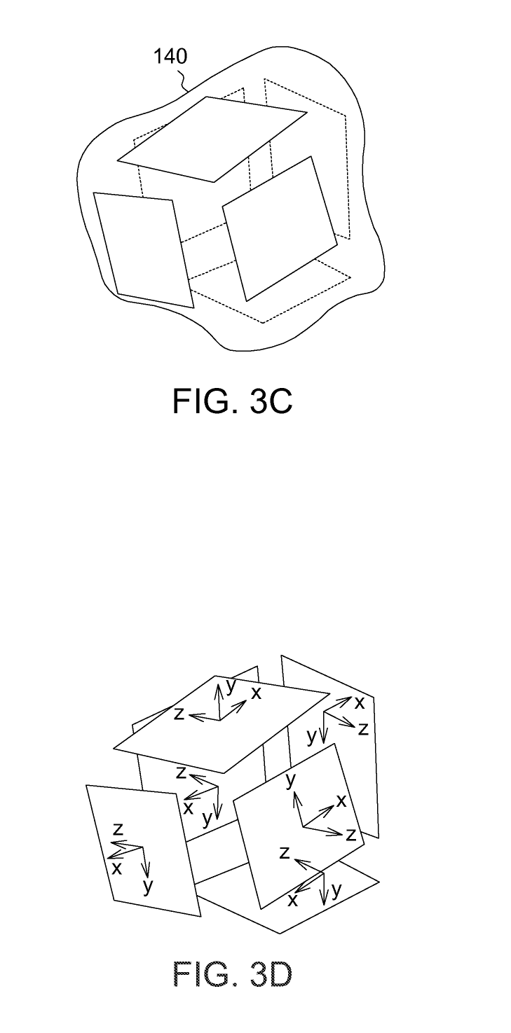

Now referring concurrently to FIG. 2 and FIGS. 3A to 3D, FIG. 2 shows a flow chart of a method for establishing a 3D object according to an embodiment, and FIGS. 3A to 3D show schematic illustrations corresponding to the method for establishing a 3D object according to an embodiment. In step S200, multiple featured patches, with different textured features, on a surface of an object 140 are captured and stored. The capturing in step S200 can be performed in real time by the image capture unit 110, or be performed in advance by other image sensing elements.

In FIG. 3A, the object 140 is such as an irregular rigid body having multiple different textured features on the surface. In FIG. 3B, multiple featured patches on the surface of the object 140 are determined by users or the processing unit 120. In an embodiment, the surface of the object 140 captured by the image capture unit 110 can be displayed on the display unit 130. Moreover, plane or near-plane zones with the obvious textured features, such as R1, R2 and R5, on the surface of the object 140 displayed on the display unit 130 can be circumscribed by input devices such as a mouse.

In another embodiment, an image analysis capture zone Rc is shown on the display unit 130. When the object 140 is manually rotated or automatically rotated on a support platform, the image analysis capture zone Rc will be fully located in the plane or near-plane to-be-analyzed zone R1 with the textured feature. When the image analysis capture zone Rc is fully located in the to-be-analyzed zone R1, the processing unit 120 detects numbers of feature points in the image analysis capture zone Rc.

When the number of the feature points exceeds a threshold, the processing unit 120 determines that the to-be-analyzed zone, with the sufficient feature points, corresponding to the image analysis capture zone Rc is the featured patch. In a preferred embodiment, the range of the image analysis capture zone Rc is slightly less than the range of the to-be-analyzed zone R1. In FIG. 3C, the featured patches are captured to be multiple images and stored, for example, in the database of the processing unit 120 for follow-up feature comparison and tracing. Take the featured patches P₁ to P₆ on the surface of the object 140 as being exemplified hereafter.

In step S210, the object 140 is hand-held or placed on a support platform, so that the image capture unit 110 detects the featured patches on the surface of the object 140 to display on the display unit 130. When any two of the neighboring featured patches (Pᵢ, Pⱼ) are shown on the display unit 130, the processing unit 120 can lock the two featured patches (Pᵢ, Pⱼ) through identification of the textured features, i and j being integers ranging form 1 to 6.

In step S220, the processing unit 120 estimates spatial information (Qᵢ, Qⱼ) of the two featured patches (Pᵢ, Pⱼ). The spatial information includes postures, positions or scales of the two featured patches (Pᵢ, Pⱼ) in the space for example. The spatial relationship between the two featured patches is shown as equation (1).

QᵢⁱSⱼ=Qⱼ (1)

ⁱSⱼ in equation (1) is the spatial relationship with Qᵢ transforming into Qⱼ. Q represents an augmented transform matrix of the spatial information of the featured patch and consists of a rotation matrix R and a translation vector t representing 3D positions. Q is shown as equation (2).

Qᵢ=[R|t] (2)

In step S230, the processing unit 120 calculates the spatial relationships of the consecutive neighboring featured patches according to the space information of the featured patches to obtain a neighboring patch relationship matrix Q₁. The spatial relationship includes relative rotations and transitions between the two featured patches. The neighboring patch relationship matrix Q₁ can only express a single stranded spatial relationship. That is, any one of the featured patches build the spatial relationships only with its neighboring featured patches. If any one of the featured patches cannot be detected by the system 100 for establishing a 3D object, it cannot be proved that the neighboring featured patches of the un-detected featured patch can be estimated by the system 100 for establishing a 3D object. The neighboring patch relationship matrix φ₁ is shown as equation (3).

$${Ω}_{1} = [ \begin{matrix}{}_{}^{1}{S}{}_{1}^{} & {}_{}^{1}{S}{}_{2}^{} & 0 & 0 & 0 & 0 \\ 0 & {}_{}^{2}{S}{}_{2}^{} & {}_{}^{2}{S}{}_{3}^{} & 0 & 0 & 0 \\ 0 & 0 & {}_{}^{3}{S}{}_{3}^{} & {}_{}^{3}{S}{}_{4}^{} & 0 & 0 \\ 0 & 0 & 0 & {}_{}^{4}{S}{}_{4}^{} & {}_{}^{4}{S}{}_{5}^{} & 0 \\ 0 & 0 & 0 & 0 & {}_{}^{5}{S}{}_{5}^{} & {}_{}^{5}{S}{}_{6}^{} \\ {}_{}^{6}{S}{}_{1}^{} & 0 & 0 & 0 & 0 & {}_{}^{6}{S}{}_{6}^{}\end{matrix} ] \qquad ( 3 )$$

In step S240, the processing unit 120 calculates the spatial relationships of any two of the non-neighboring featured patches based on the neighboring patch relationship matrix Ω₁ to obtain the spatial relationship matrix Ω₂, shown as equation (4). ^{j}Sⱼ and ^{j}Sᵢ are inverse matrices with each other. Thus the spatial relationship matrix Ω₂ is solely to be an upper triangular matrix or a lower triangular matrix to represent the mutual spatial relationships between all the featured patches.

While obtaining Ω₂ from Ω₁, it can spread the spatial relationships between the neighboring patches to those between the non-neighboring patches by the following equation, ⁱSₖ=ⁱSⱼ^{j}Sₖ. ⁱSⱼ and ^{j}Sₖ respectively represent the spatial relationships of two set of the neighboring patches. That is, the featured patch Pᵢ is neighboring to the featured patch Pⱼ, and the featured patch Pⱼ is neighboring to the featured patch Pₖ. The spatial relationship ⁱSₖ between the non-neighboring textured patches Pᵢ and Pₖ can be obtained via the textured patch Pⱼ. In addition, ⁱSᵢ represents the spatial relationship between the featured patch Pᵢ and itself; that is, there is no rotation or transition, and thus ⁱSᵢ is simplified into the identity matrix I. Ω₂ can be obtained from Ω₁ by following the above steps. Consequently, it ensures that the spatial information of any one of the featured patches can be estimated by the at least one viewable feature patch any time.

$${Ω}_{2} = [ \begin{matrix}I & {}_{}^{1}{S}{}_{2}^{} & {}_{}^{1}{S}{}_{3}^{} & {}_{}^{1}{S}{}_{4}^{} & {}_{}^{1}{S}{}_{5}^{} & {}_{}^{1}{S}{}_{6}^{} \\ 0 & I & {}_{}^{2}{S}{}_{3}^{} & {}_{}^{2}{S}{}_{4}^{} & {}_{}^{2}{S}{}_{5}^{} & {}_{}^{2}{S}{}_{6}^{} \\ 0 & 0 & I & {}_{}^{3}{S}{}_{4}^{} & {}_{}^{3}{S}{}_{5}^{} & {}_{}^{3}{S}{}_{6}^{} \\ 0 & 0 & 0 & I & {}_{}^{4}{S}{}_{5}^{} & {}_{}^{4}{S}{}_{6}^{} \\ 0 & 0 & 0 & 0 & I & {}_{}^{5}{S}{}_{6}^{} \\ 0 & 0 & 0 & 0 & 0 & I\end{matrix} ] \qquad ( 4 )$$

The said steps S230 and S240 mainly utilize the processing unit 120 to build the spatial relationship matrix Ω₂ corresponding to the featured patches according to the space information of the detected featured patches.

When the spatial relationship matrix Ω₂ is built, in step S250, the processing unit 120 is able to trace and describe each feature patch of the object 140 according to the spatial relationship matrix Ω₂. In step S250, the processing unit 120 substantially obtains mutual spatial relationships between the featured patches on the surface of the object 140 according to the spatial relationship matrix Ω₂. The processing unit 120 can estimate the space information of the other featured patches, shaded and not shown on the display unit 130 or impossible to be stably identified and locked, from the space information of any one of the featured patches, shown on the display unit and identified, according to the spatial relationships.

According to said identification and lock, the processing unit 120 can substantially obtain the spatial position and direction of any one of the featured patches any time, and thus the processing unit 120 can make virtual augmented information overlay at least one of the featured patches of the object 140. For example, the processing unit 120 can make the virtual augmented information overlay the surfaces of the featured patches, or make the virtual augmented information move or rotate between the patches. Afterwards, the display unit 130 is utilized to display the object 140 and corresponding continuing augmented digital matters that overlays the object 140, without destroying the immersive of the augmented reality applications.

The method and the system for establishing a 3D object proposed in the embodiments of the disclosure detect the featured patches with different textures on the surface of an object, establish mutual spatial relationships based on postures of the specific featured patches with different textured features, and trace and describe the object according to the spatial relationships. Thus it builds a basis of the follow-up addition of augmented information of 3D augmented reality applications and vision interactions, and it is suitable to general users.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A method for establishing a 3D object, comprising:
capturing and storing a plurality of featured patches, with different textured features, on a surface of an object;
utilizing an image capture unit to detect the featured patches on the surface of the object
utilizing a processing unit to build a spatial relationship matrix corresponding to the featured patches according to detected space information of the featured patches; and
utilizing the processing unit to trace and describe the object according to the spatial relationship matrix.

2. The method for establishing a 3D object according to claim 1, further comprising:
displaying the surface of the object captured by the image capture unit on a display unit; and
circumscribing the featured patches from the surface of the object displayed on the display unit.

3. The method for establishing a 3D object according to claim 2, wherein the featured patches are plane or near-plane zones, with the obvious textured features, on the surface of the object.

4. The method for establishing a 3D object according to claim 1, wherein the featured patches are determined by detecting numbers of feature points in an image analysis capture zone, which locates in a plane or near-plane to-be-analyzed zone with the obvious textured feature.

5. The method for establishing a 3D object according to claim 4, wherein when the numbers of the feature points in the image analysis capture zone exceeds a threshold, the to-be-analyzed zone corresponding to the image analysis capture zone is determined as the feature patch.

6. The method for establishing a 3D object according to claim 4, wherein the range of the image analysis capture zone is slightly less than the range of the corresponding to-be-analyzed zone.

7. The method for establishing a 3D object according to claim 1, wherein the space information of the featured patches include postures, positions or scales of the featured patches in the space.

8. The method for establishing a 3D object according to claim 1, wherein the step of building the spatial relationship matrix comprises:
utilizing the processing unit to estimate the space information of the featured patches;
utilizing the processing unit to calculate spatial relationships of the consecutive neighboring featured patches according to the space information of the featured patches to obtain a neighboring patch relationship matrix; and
utilizing the processing unit to calculate spatial relationships of any two of the non-neighboring featured patches based on the neighboring patch relationship matrix to obtain the spatial relationship matrix.

9. The method for establishing a 3D object according to claim 8, wherein the spatial relationships between the featured patches include relative rotations and transitions between any two of the featured patches.

10. The method for establishing a 3D object according to claim 1, wherein the step of utilizing the processing unit to trace and describe the object according to the spatial relationship matrix comprises:
utilizing the processing unit to obtain mutual spatial relationships between the featured patches on the surface of the object; and
utilizing the processing unit to estimate the space information of the other featured patches, not shown on the display unit or impossible to be stably identified, from the space information of the featured patches, shown on the display unit and identified, according to the spatial relationships.

11. The method for establishing a 3D object according to claim 10, further comprising:
utilizing the processing unit to make virtual augmented information overlay at least one of the featured patches to be displayed on the display unit.

12. A system for establishing a 3D object, comprising:
an image capture unit for capturing and storing a plurality of featured patches, with different textured features, on a surface of an object; and
a processing unit for building a spatial relationship matrix corresponding to the featured patches according to detected space information of the featured patches after the image capture unit detects the featured patches, and tracing and describing the object according to the spatial relationship matrix.

13. The system for establishing a 3D object according to claim 12, further comprising;
a display unit for displaying the surface of the object captured by the image capture unit to be circumscribed;
wherein the featured patches are determined by the circumscribed plane or near-plane zones with the obvious textured features.

14. The system for establishing a 3D object according to claim 12, wherein the featured patches are determined by detecting numbers of feature points in an image analysis capture zone, which locates in a plane or near-plane to-be-analyzed zone with the obvious textured feature.

15. The system for establishing a 3D object according to claim 14, wherein when the numbers of the feature points in the image analysis capture zone exceeds a threshold, the processing unit determines that the to-be-analyzed zone corresponding to the image analysis capture zone is the feature patch.

16. The system for establishing a 3D object according to claim 14, wherein the range of the image analysis capture zone is slightly less than the range of the corresponding to-be-analyzed zone.

17. The system for establishing a 3D object according to claim 12, wherein the space information of the featured patches include postures, positions or scales of the featured patches in the space.

18. The system for establishing a 3D object according to claim 12, wherein the processing unit further estimates the space information of the featured patches, calculates spatial relationships of the consecutive neighboring featured patches according to the space information of the featured patches to obtain a neighboring patch relationship matrix, and calculates spatial relationships of any two of the non-neighboring featured patches based on the neighboring patch relationship matrix to obtain the spatial relationship matrix.

19. The system for establishing a 3D object according to claim 18, wherein the spatial relationships between the featured patches include relative rotations and transitions between any two of the featured patches.

20. The system for establishing a 3D object according to claim 12, further comprising:
a display unit for displaying the surface of the object captured by the image capture unit;
wherein the processing unit further obtains mutual spatial relationships between the featured patches on the surface of the object according to the spatial relationship matrix, and estimates the space information of the other featured patches, not shown on the display unit or impossible to be stably identified, from the space information of the featured patches, shown on the display unit and identified, according to the spatial relationships.

21. The system for establishing a 3D object according to claim 20, wherein the processing unit makes virtual augmented information overlay at least one of the featured patches to be displayed on the display unit.
